(19) United States
(12) Patent Application Publication
(10) Pub. No.: US 2015/0161029 A1
(43) Pub. Date: Jun. 11, 2015

(54) GUIDED BUSINESS PROCESS TESTING

(71) Applicant: ROMAN RAPP, VILLENEUVE LOUBET (FR)

(72) Inventor: ROMAN RAPP, VILLENEUVE LOUBET (FR)

(21) Appl. No.: 14/103,833

(22) Filed: Dec. 11, 2013

(51) Int. Cl. G06F 11/36; G06Q 10/06

(52) U.S. Cl. CPC G06F 11/3688; G06Q 10/06311

(57) ABSTRACT

Enterprise applications are disclosed that support various business processes that are associated with a set of test plans. In a test phase of the application management life cycle, such business processes can be tested by generating test plans. Test steps associated with a business process are received in a sequence at a user interface. The test steps include test activities. Scheduling information for the test activities is received at the user interface. Test systems are assigned to the test steps. The test steps are executed in the assigned test systems. Testers are assigned to the one or more test activities such that the test activities are executed by the assigned tester. A guided test procedure is generated based on the received test steps, scheduling information, assignment of test systems, and assignment of testers.

### BACKGROUND

Some enterprises provide an embedded environment for customers or vendors to provide integrated content, tools and methodologies required to implement, support, operate and monitor enterprise applications. Such an embedded environment offers features and functionalities that support various phases of the application management life cycle. Phases of the application management life cycle include requirements, design, build, test, deploy, operate, optimize, etc. In such an embedded environment, one phase of the application management life cycle provides a test landscape, where a test plan and associated tests can be generated. These tests are based on business processes. The tests are typically displayed in a hierarchy under the test plan. Specific tests may be executed in corresponding test systems. While a tester works on these tests, individual tests are required to be opened, and manually a connection is required to be established with the corresponding test systems. Thus it is challenging to manually connect with the test systems for executing individual tests.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating a user interface for generating a guided test procedure, according to one embodiment.

FIG. 2 is a block diagram illustrating a user interface for adding test steps in a sequence to the guided test procedure, according to one embodiment.

FIG. 3 is a block diagram illustrating a user interface for displaying the guided test procedure, according to one embodiment.

FIG. 4 is a block diagram illustrating a user interface for assigning test systems to test steps, according to one embodiment.

FIG. 5 is a block diagram illustrating a user interface for assigning testers to test activities, according to one embodiment.

FIG. 6 is a block diagram illustrating a user interface for displaying test activities assigned to testers as tasks, according to one embodiment.

FIG. 7 is a block diagram illustrating a user interface for setting status associated with test activities assigned to testers, according to one embodiment.

FIG. 8 is a block diagram illustrating a user interface for displaying test activities within a test step, according to one embodiment.

FIG. 9 illustrates a flow diagram of a process of guided business process testing, according to one embodiment.

FIG. 10 is a block diagram of an exemplary computer system according to one embodiment.

### DETAILED DESCRIPTION

Embodiments of techniques for guided business process testing are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Enterprise applications support various business processes, and individual business process is associated with a set of test plans. In a test phase of the application management life cycle, such business processes can be tested by generating test plans. Testing is performed to validate proper functioning of business processes in the enterprise application. Test plans include test steps, test steps include test activities, and test activities are associated with test cases. A test case is a set of instructions or steps used by a tester to determine if an application or system under test performs as expected. Test steps may be manual test steps or automated test steps. A tester can be a manual test user executing the test steps or a software application or software code that automatically executes the test steps. In an enterprise application, a guided test procedure is used to guide testers to test business processes. In guided test procedures, test plans associated with the business process are provided to the testers in a step by step manner.

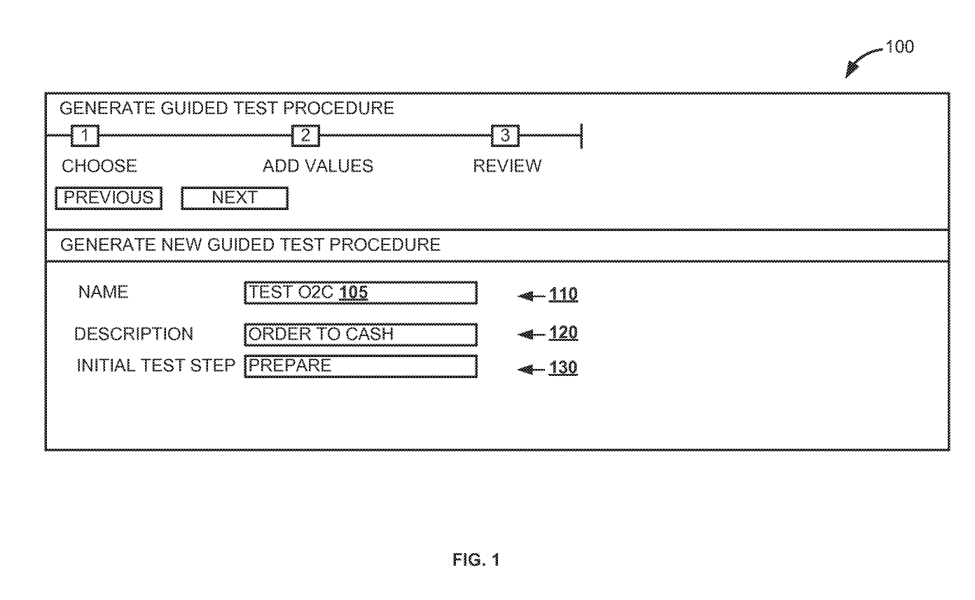

FIG. 1 is a block diagram illustrating user interface 100 for generating a guided test procedure, according to one embodiment. For example, a business process ‘order to cash’ can be tested by generating a guided test procedure. In the user interface 100 for generating the guided test procedure, the name of the guided test procedure for the business process ‘order to cash’ is specified as ‘Test O2C’ 105 as shown in 110. A description associated with the guided test procedure is specified in 120. An initial test step is specified as ‘prepare’ as shown in 130. The guided test procedure ‘Test O2C’ 105 can be reviewed (not shown) if required using appropriate options. Options may include any user interface elements such as a button, a link, a hyperlink, a dropdown, a text box, a toggle button, a pick list, a radio button, and the like.

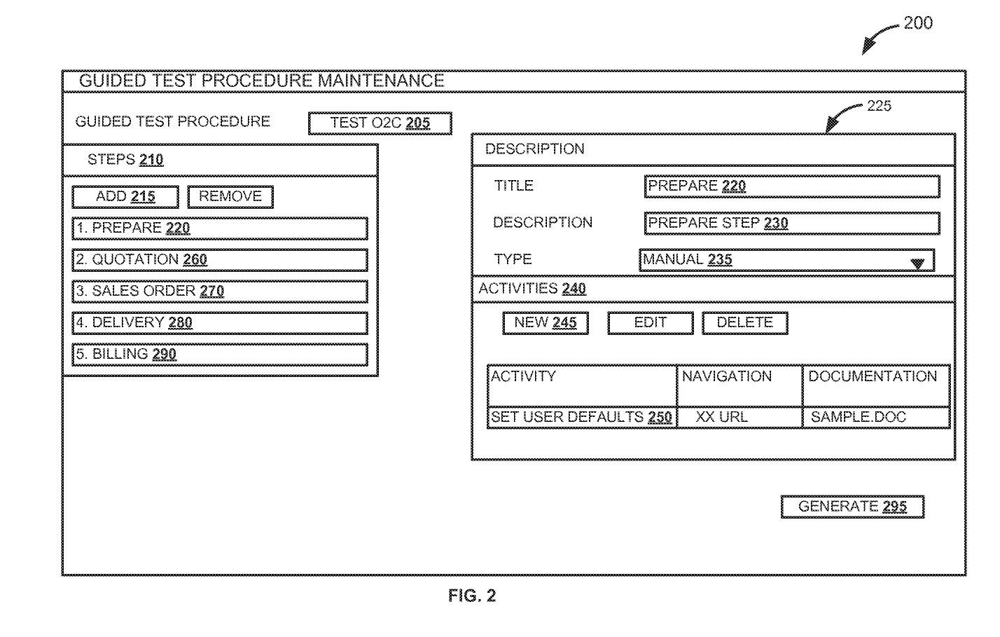

Test steps can be added to the guided test procedure ‘Test O2C’. FIG. 2 is a block diagram illustrating user interface 200 for adding test steps in a sequence to the guided test procedure, according to one embodiment. For the guided test procedure ‘Test O2C’ 205 test steps can be added in ‘steps’ 210 section using the ‘add’ 215 option. When ‘add’ 215 option is clicked, a form 225 to add test step is provided as shown in the right portion of the user interface 200. Test step named ‘prepare’ 220 is added by specifying a description as ‘prepare step’ 230 of type ‘manual’ 235 test step. The input type indicates the type of test such as manual or automated. Test step includes test activities, and test activities include test cases. Test activities can be added for the test step named ‘prepare 220’ by using the ‘new’ 245 option and is displayed in activities 240. Test activity named ‘set user defaults’ 250 is added to the ‘prepare’ 220 test step. Various parameters such as navigation, documentation, etc., can be specified for the test activity ‘set user defaults’ 250. Similarly other test steps such as quotation 260, sales order 270, delivery 280 and billing 290 are added in sequence for the guided test procedure ‘TestO2C’ 205. After the required test steps are added, the guided test procedure named ‘TestO2C’ 205 can be generated using ‘generate’ 295 option. In one embodiment, the guided test procedure can be generated first and the test steps can be added later.

In one embodiment, guided test procedures can be generated automatically from existing business processes including business steps. For example, when a guided test procedure is generated for a business process ‘create invoice’, name of the business process gets added as the name of the guided test procedure. Individual steps within the business process ‘create invoice’ such as ‘purchase order’, ‘account information’, etc., will be added as test steps within the guided procedure ‘create invoice’ as ‘purchase order’, ‘account information’, etc. Within the individual test step ‘create invoice’, an activity ‘create invoice’ with the same name as the test step is added. In the activity ‘create invoice’, any associated uniform resource locators for navigation and documentation are added automatically. In case the step ‘create invoice’ includes automatic tests, the automated tests are added to the activity in the ‘create invoice’ step. This automatically generated guided procedure ‘create invoice’ can be manually edited if required to add or edit information.

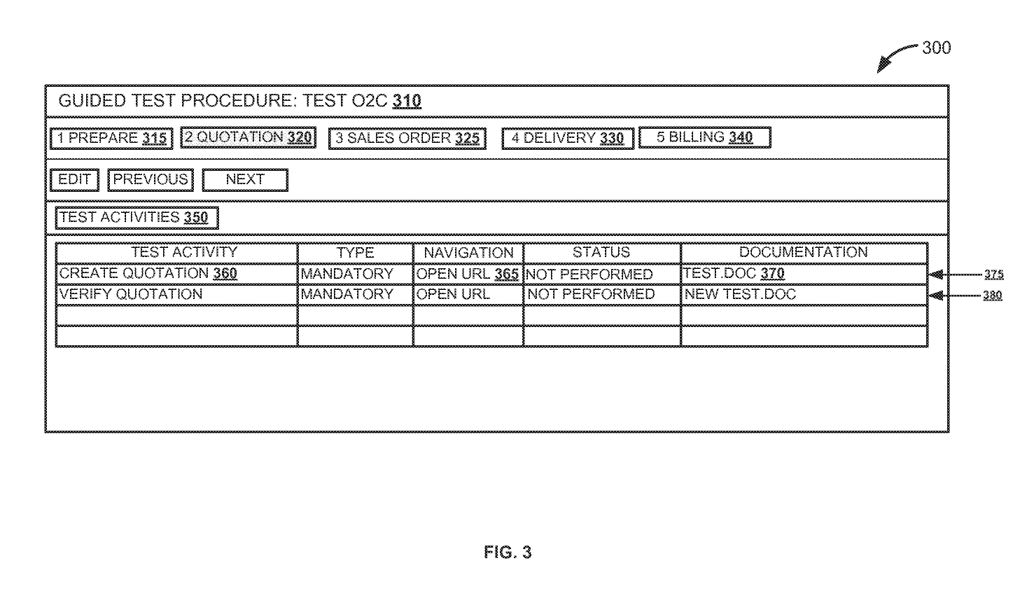

FIG. 3 is a block diagram illustrating user interface 300 for displaying the guided test procedure, according to one embodiment. By way of example, a guided test procedure for ‘order to cash’ named ‘Test O2C’ 310 is illustrated below. In the guided test procedure named ‘Test O2C’ 310, various test steps added in FIG. 2 are displayed. Test steps such as prepare 315, quotation 320, sales order 325, delivery 330 and billing 340 are displayed. For example, in the test step ‘quotation’ 320, test activities added such as create quotation, verify quotation, etc., are displayed using test activities 350 option. Test activity named ‘create quotation’ 360 is displayed with test type ‘mandatory’, navigation ‘open URL’ 365, status ‘not performed’ and documentation ‘test.doc’ 370 as shown in 375. Navigation ‘Open URL’ 365, is used to provide a uniform resource locator (URL) to a corresponding test system where test activity named ‘create quotation’ 360 is to be performed. A test system is a system or a software application where a tester executes the test activities. Some examples of test systems are enterprise resource planning (ERP) system, customer relationship management (CRM), etc. Similarly, test activity for verify quotation is also displayed as shown in 380.

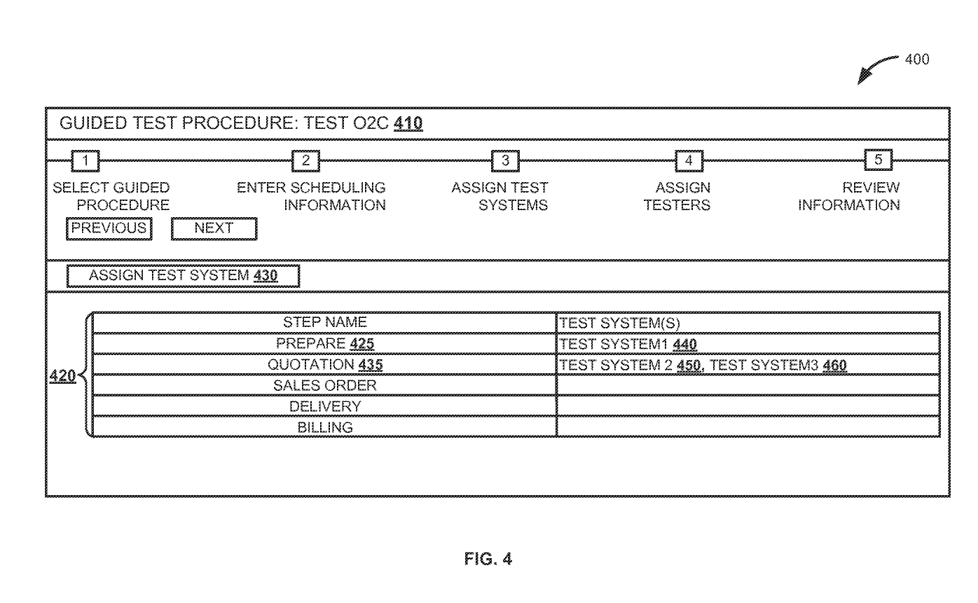

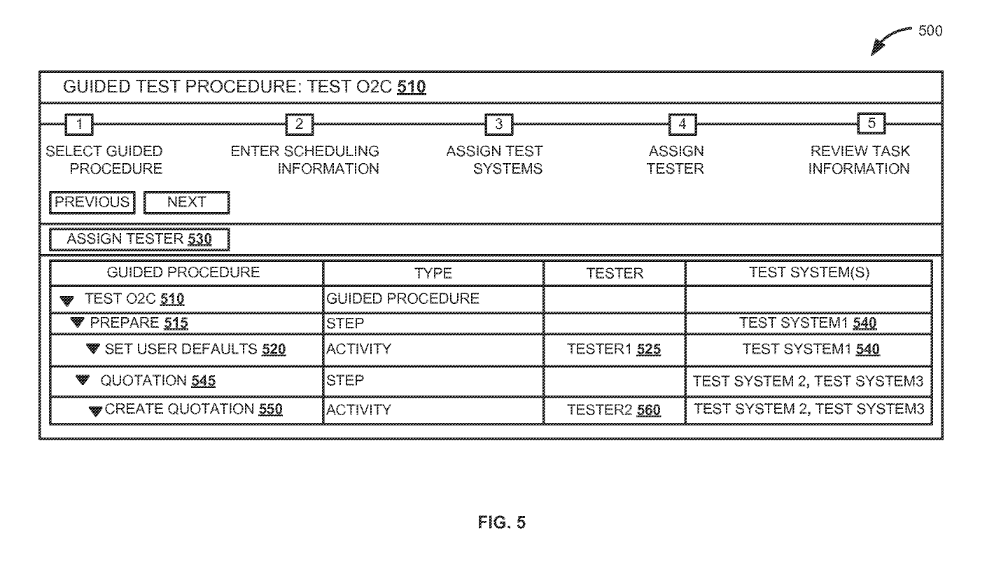

In FIG. 4 and FIG. 5, the generated guided test procedure can be selected and operations such as scheduling information, test system assignment, etc., can be performed. To schedule a guided test procedure (not shown), ‘start date’ and ‘due date’ can be specified for the selected guided test procedure indicating that the guided test procedure is to be completed within the specified dates. In one embodiment, independent test steps may be required to be executed in different test systems. For example, in the guided test procedure named ‘Test O2C’, individual test steps are performed in different test systems. FIG. 4 is a block diagram illustrating user interface 400 for assigning test systems to test steps, according to one embodiment. For the guided test procedure named ‘Test O2C’ 410, test steps such as prepare 425, quotation 435, sales order, delivery and billing are displayed as shown in 420. Test systems can be assigned to these test steps using ‘assign test system’ 430 option. For example, using ‘assign test system’ 430 option, test step ‘prepare’ 425 can be assigned test system ‘test system1’ 440. In one embodiment, for an individual test step, one or more test systems may be assigned. For example, for the test step ‘quotation’ 435, test systems such as ‘test system2’ 450 and ‘test system3’ 460 are assigned. Login details corresponding to test systems are pre-configured while adding test steps to the guided test procedure. While executing the test step ‘quotation’ 435, the tester is automatically directed to the test systems ‘test system2’ 450 and ‘test system3’ 460, and the tester is not required to login individually to the ‘test system2’ 450 and ‘test system3’ 460.

The next step is to assign testers to test activities in a test step. FIG. 5 is a block diagram illustrating user interface 500 for assigning testers to test activities, according to one embodiment. For the guided test procedure, test steps along with test activities are displayed. For example, in the guided test procedure named ‘Test O2C’ 510, test step ‘prepare’ 515 along with test activity ‘set user defaults’ 520 are displayed. Some business scenarios might involve different business experts such as one tester from Enterprise resource planning (ERP) domain, one tester from Customer relationship management (CRM) domain, etc., to participate in a business process testing. Accordingly, different testers can be assigned to individual test activity in test steps. For example, using the ‘assign tester’ 530 option, tester ‘tester1’ 525 may be assigned to individual test activity named ‘set user defaults’ 520 in test step ‘prepare’ 515. ‘Tester1’ 525 can execute the assigned test activity named ‘set user defaults’ 520 in the test system ‘test system1’ 540. In one embodiment, ‘tester2’ 560 can be assigned to test activity ‘create quotation’ 550 in test step ‘quotation’ 545. In one embodiment, upon completion of execution of the test activity ‘set user defaults’ 520 by ‘tester1’ 525, an automatic notification or alert can be sent to ‘tester2’ 560 notifying that ‘tester1’ 525 has completed execution of the test activity ‘set user defaults’ 520. This notification helps subsequent tester ‘tester2’ 560 to start execution of test activity named ‘create quotation’ 550. Accordingly, upon completion of execution of a test activity by a tester, an automatic notification is sent to the subsequent tester testing the next test step.

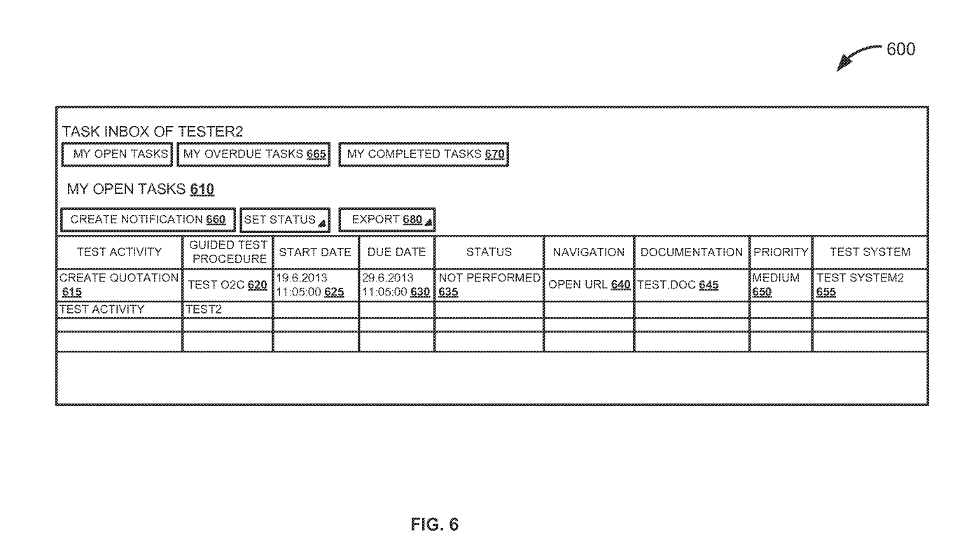

Once testers are assigned to test activities, testers can view the test activities assigned to them as tasks in their task inbox. FIG. 6 is a block diagram illustrating user interface 600 for displaying test activities assigned to testers as tasks, according to one embodiment. Test activities assigned to individual testers are displayed in ‘my open tasks’ 610. For example, ‘tester2’ is displayed the test activity assigned to ‘tester2’ in ‘my open tasks’ 610. In ‘my open tasks’ 610, test activity ‘create quotation’ 615 in guided test procedure named ‘Test O2C’ 620, scheduled with a start date ‘19.6.2013 11:05:00’ 625 and a due date ‘29.6.2013 11:05:00’ 630, with ‘not performed’ 635 status, navigation ‘open URL’ 640, documentation ‘test.doc’ 645, ‘medium’ 650 priority, and test system ‘test system2’ 655 are displayed. Similarly, other test activities assigned to tester2 are displayed in ‘my open tasks’ 610.

During the execution of test activity ‘create quotation’ 615, tester2 can click on the uniform resource location specified in navigation ‘open URL’ 640, and tester2 will automatically be directed or navigated to the corresponding test system ‘test system2’ 655 which is linked to the navigation ‘open URL’640. The tester can automatically login to the ‘test system2’ 655 based on a set of pre-configured login details. During the execution of the test activity ‘create quotation’ 615, document specified in documentation ‘test.doc’ 645 can be used or referred to. Using the ‘create notification’ 660 option ‘tester2’ can notify the completion of test activity to the next tester ‘tester3’. Using ‘my overdue tasks’ 665 option, ‘tester2’ can view the overdue tasks assigned to ‘tester2’ which are past the due date. Similarly, ‘tester2’ can view the completed tasks using ‘my completed tasks’ 670 option. Upon completion of test activity, ‘tester2’ can set or alter the status of test activity ‘create quotation’ 615 from ‘not performed’ 635 to ‘performed’. Test activities can be exported using the ‘export’ 680 option.

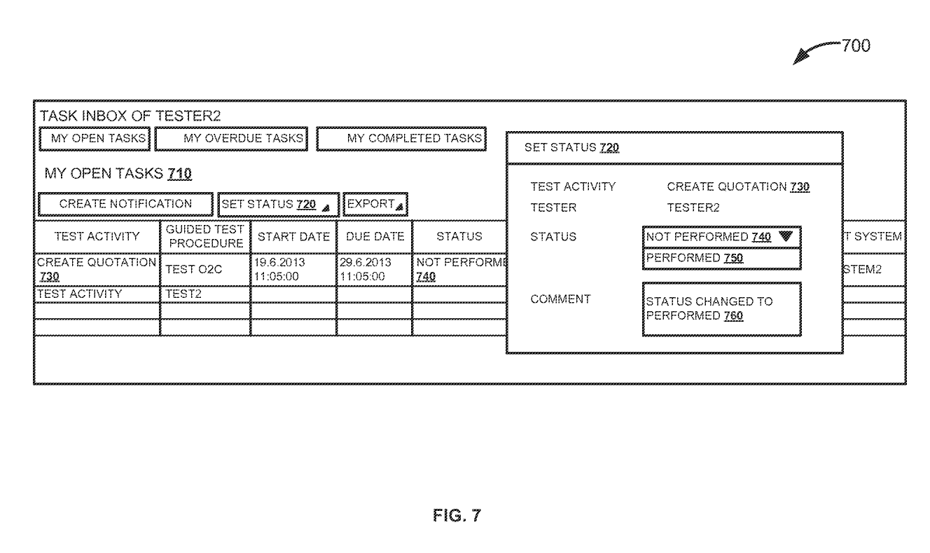

FIG. 7 is a block diagram illustrating user interface 700 for setting or altering statuses associated with test activities assigned to testers, according to one embodiment. Test activities assigned to individual testers are displayed in ‘my open tasks’ 710. ‘Tester2’ can work on the assigned test activity, and upon completion of the test activity, change the status of the test activity. For example, using the ‘set status’ 720 option, status of the test activity ‘create quotation’ 730 can be changed from ‘not performed’ 740 to ‘performed’ 750. Comments such as ‘status changed to performed’ 760 can be specified in the comments section.

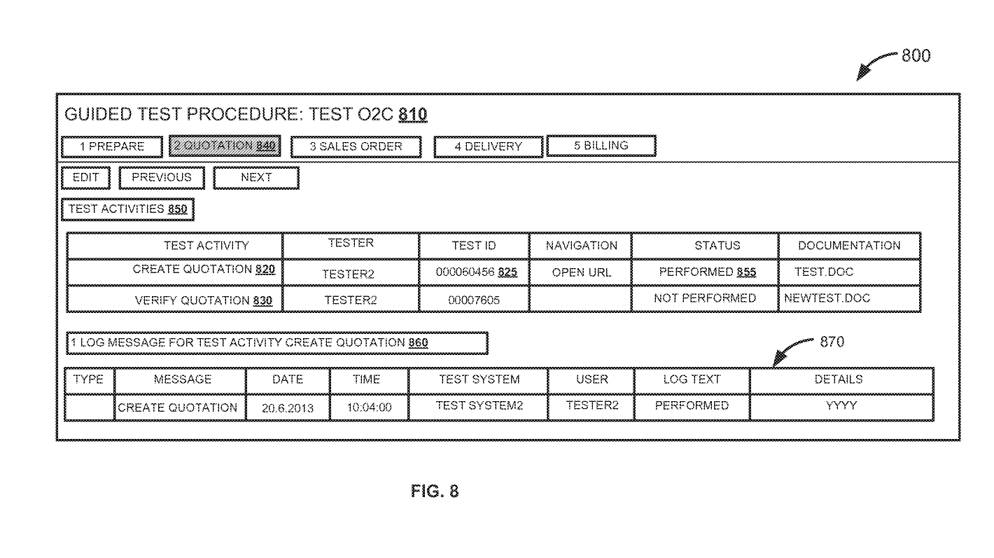

The status of a test step depends on the status of test activities within the test step. FIG. 8 is a block diagram illustrating user interface 800 for displaying test activities within a test step, according to one embodiment. In the guided test procedure ‘TestO2C’ 810, test activities ‘create quotation’ 820 and ‘verify quotation’ 830 within test step ‘quotation’ 840 are displayed using ‘test activities’ 850 option. Individual test activities are identified using test-id. For example, ‘create quotation’ 820 test activity is identified using test-id ‘000060456’ 825. Any task performed on test activities is logged. For example, if the test activity ‘create quotation’ 820 is set to status ‘performed’ 855 from ‘not performed’, then this activity is logged in the section below as ‘1 log message for test activity create quotation’ 860, where ‘1’ is a numeral indicating the number of log messages. In log window 870, log details for setting the status of test activity ‘create quotation’ to ‘performed’ are displayed. In various embodiments, log details include the time stamp and name of the tester as well. This information is used for audit and compliance purposes. Along with the status information ‘test data’ such as test output, test success message, etc., can also be stored to enable other testers to use them.

The status of test step ‘quotation’ 840 is based on the status of all the test activities with the test step ‘quotation’. For example, when the status of test activities ‘create quotation’ and ‘verify quotation’ are performed then the status of test step ‘quotation’ can be marked as ‘performed’ 855. In case of an automated test step including automated test activities, the execution of the test activities is automatic, and the result of test execution is logged in the log window 870. If the status of the automated test activities is ‘performed’, then the status of the automated test step is automatically set to ‘performed’. Based on the status of test step, progress of a test can be monitored. In one embodiment, an application programming interface (API) may be implemented to automatically read test related information generated by the test systems, and use it for further processing such as reporting purposes.

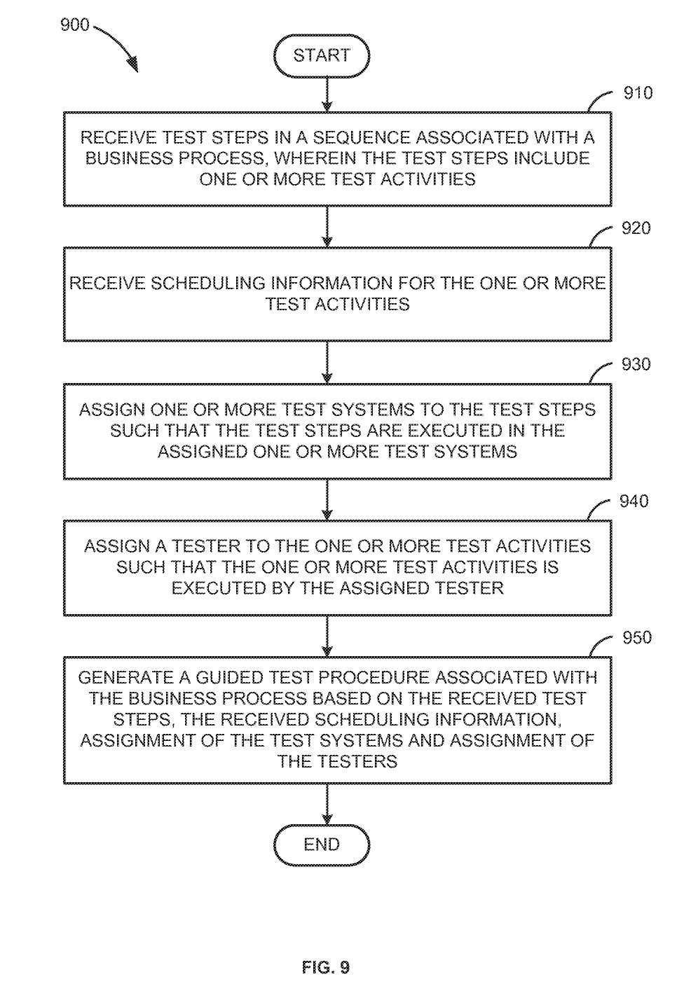

FIG. 9 illustrates a flow diagram of process 900 of guided business process testing, according to one embodiment. At 910, test steps associated with a business process are received in a sequence in a user interface. The test steps include one or more test activities. At 920, scheduling information for the one or more test activities is received. At 930, one or more test systems are assigned to the test steps. The test steps are executed in the assigned one or more test systems. At 940, a tester is assigned to the one or more test activities such that the one or more test activities are executed by the assigned tester. At 950, a guided test procedure is generated based on the received test steps, the received scheduling information, assignment of the test systems, and assignment of the testers.

The various embodiments described above have a number of advantages. Guided business process testing enables users to work on the test steps and transact with the individual test systems using an automatic login in feature. This reduces the manual effort required to login to individual test systems. The log information and test data enables subsequent testers to continue with the testing process at ease. Testers can view the test activities assigned to them in task inbox. Testers can also keep track of the tests performed by them in task inbox. Upon completion of execution of a test activity, subsequent a tester is sent an automatic notification. This helps testers to start their tests in a timely manner. Guided test procedures also provide a functionality of adding both manual and automated test steps providing convenience to test designers. Using guided test procedures, overall manual effort by testers is significantly reduced and productivity is increased.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

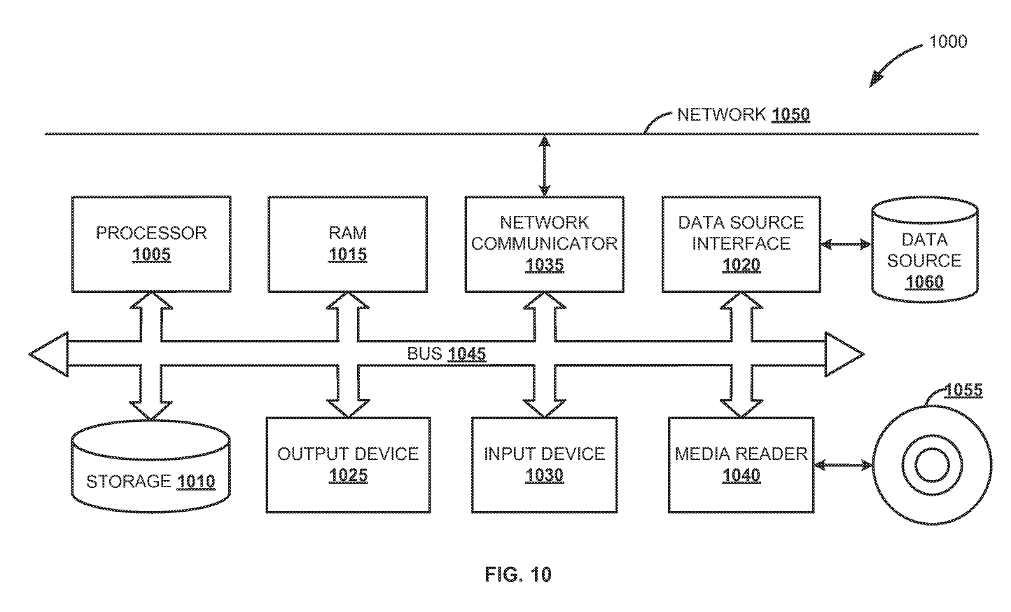

FIG. 10 is a block diagram of an exemplary computer system 1000. The computer system 1000 includes a processor 1005 that executes software instructions or code stored on a computer readable storage medium 1055 to perform the above-illustrated methods. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. The stored instructions may be further compiled to generate other representations of the instructions and dynamically stored in the RAM 1015. The processor 1005 reads instructions from the RAM 1015 and performs actions as instructed. According to one embodiment, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
receive a sequence of test steps associated with a business process, wherein the test steps comprise one or more test activities;
receive scheduling information for the one or more test activities;
assign one or more test systems to the test steps such that the test steps are executed in the assigned one or more test systems;
assign a tester to the one or more test activities such that the one or more test activities are executed by the assigned tester; and
generate a guided test procedure associated with the business process based on the received test steps, the received scheduling information, the assignment of the one or more test systems and the assignment of the tester.

2. The computer-readable medium of claim 1 to store instructions, which when executed by the computer, cause the computer to perform operations further comprising:
automatically login in the tester to the one or more test systems; and
execute the one or more test activities in the assigned one or more test systems.

3. The computer-readable medium of claim 2 to store instructions, which when executed by the computer, cause the computer to perform operations further comprising:
send automatic notifications to a subsequent tester, upon completion of execution of the one or more test activities.

4. The computer-readable medium of claim 1, wherein the test steps comprise manual test steps and automated test steps.

5. The computer-readable medium of claim 1 to store instructions, which when executed by the computer, cause the computer to perform operations further comprising:
set a status corresponding to the one or more test activities.

6. The computer-readable medium of claim 1 to store instructions, which when executed by the computer, cause the computer to perform operations further comprising:
display the one or more test activities assigned to the tester in a task inbox of the tester; and
log one or more tasks performed on the one or more test activities in a log window.

7. The computer-readable medium of claim 1 to store instructions, which when executed by the computer, cause the computer to perform operations further comprising:
automatically generate a guided test procedure associated with the business process based on the received sequence of test steps from an existing business process.

8. A computer implemented method for guided business process testing, the method comprising:
receiving a sequence of test steps associated with a business process, wherein the test steps comprise one or more test activities;
receiving scheduling information for the one or more test activities;
assigning one or more test systems to the test steps such that the test steps are executed in the assigned one or more test systems;
assigning a tester to the one or more test activities such that the one or more test activities are executed by the assigned tester; and
generating a guided test procedure associated with the business process based on the received test steps, the received scheduling information, the assignment of the one or more test systems and the assignment of the tester.

9. The method of claim 8, further comprising:
automatically log in the tester to the one or more test systems; and
executing the one or more test activities in the assigned one or more test systems.

10. The method of claim 9, further comprising:
sending automatic notifications to a subsequent tester, upon completion of execution of the one or more test activities.

11. The method of claim 8, wherein the test steps comprise manual test steps and automated test steps.

12. The method of claim 8, further comprising:
setting a status corresponding to the one or more test activities.

13. The method of claim 8, further comprising:
displaying the one or more test activities assigned to the tester in a task inbox of the tester; and
logging one or more tasks performed on the one or more test activities in a log window.

14. The method of claim 8, further comprising:
automatically generating a guided test procedure associated with the business process based on the received steps from an existing business process.

15. A computer system for guided business process testing, comprising:
a computer memory to store program code; and
a processor to execute the program code to:
receive a sequence of test steps associated with a business process, wherein the test steps comprise one or more test activities;
receive scheduling information for the one or more test activities;
assign one or more test systems to the test steps such that the test steps are executed in the assigned one or more test systems;
assign a tester to the one or more test activities such that the one or more test activities are executed by the assigned tester; and
generate a guided test procedure associated with the business process based on the received test steps, the received scheduling information, the assignment of the one or more test systems and the assignment of the tester.

16. The system of claim 15, wherein the processor further executes the program code to:
automatically log in the tester to the one or more test systems;
execute the one or more test activities in the assigned one or more test systems; and
log one or more tasks performed on the one or more test activities in a log window.

17. The system of claim 16, wherein upon completion of execution of the one or more test activities, send automatic notifications to a subsequent tester.

18. The system of claim 15, wherein the test steps comprise manual test steps and automated test steps.

19. The system of claim 15, wherein the processor further executes the program code to:
set a status corresponding to the one or more test activities; and
display the one or more test activities assigned to the tester in a task inbox of the tester.

20. The system of claim 15, wherein the processor further executes the program code to:
automatically generate a guided test procedure associated with the business process based on the received steps from an existing business process.
